(19) United States
(12) Patent Application Publication
(10) Pub. No.: US 2008/0220815 A1
(43) Pub. Date: Sep. 11, 2008

(54) Personal Communication System Based on the Use of Mobile Telephony, and Device and Telephone Used in Said System

(76) Inventor: Jordi Badia I Farre, Barcelona (ES)

Correspondence Address: GOTTLIEB RACKMAN & REISMAN PC, 270 MADISON AVENUE, 8TH FLOOR, NEW YORK, NY, 10016-0601, US

(21) Appl. No.: 11/813,300

(22) PCT Filed: Nov. 29, 2005
(86) PCT No.: PCT/IB2005/003703

§ 371 Date: Jul. 3, 2007

(30) Foreign Application Priority Data
Dec. 13, 2004 (ES) P-200402950

(51) Int. Cl. H04M 1/00

(52) U.S. Cl. 455/556.1

(57) ABSTRACT

It includes a telephone (1) with a first radiofrequency electromagnetic wave and/or microwave emitting-receiving unit (7), and is characterised in that it includes at least one independent device (2), which device (2) includes a second wave emitting unit, means for connecting said device (2) and said telephone (1) wirelessly and means for deactivating said first emitting unit from said telephone (1) and activating said second emitting unit of said device (2). It reduces the intensity of radiation received by the user.

This invention relates to a personal communication system based on the use of mobile telephony and including means for protection against the radiation generated during its use, and to a device and telephone for use in said system.

### BACKGROUND OF THE INVENTION

It is known that the reception and emission of messages by means of mobile telephones involves the generation, transmission and picking up of radiofrequency electromagnetic waves and/or microwaves that can prove detrimental to the health of the user.

Indeed, it is known that continued exposure to the radiation from radiofrequency electromagnetic waves and/or microwaves can act negatively upon the human body, for example by giving rise to thermal alterations in the tissues, by altering the permeability of the cells and/or by interfering with the biological electromagnetic fields. These effects cause irritability, insomnia, headaches and lowered defenses, among other afflictions.

Thus, it is known that vital organs, such as the brain, can be affected by continued exposure to mobile telephony radiofrequency. More specifically, it is known that the pineal gland in the brain is altered by the effect of electromagnetic fields. This gland segregates the hormone melatonin, which plays a primordial role in maintenance of the immune system and regulates the growth of the body cells. Alterations to this gland have a negative effect on infectious processes and allergies, as well as on the abnormal growth of cancer cells.

Children, whose skull bones are of much lower thickness than those of adults, are particularly sensitive to negative effects arising from continued exposure to the type of radiation described.

The intensity of the electromagnetic field to which a user of a mobile telephone is exposed is measured in terms of density levels of radiation power flow (microWatios/cm²) to which that user is exposed. International organizations (Council of the European Union, 519/CE, of 12 Jul. 1999) recommend reference levels of power flow density that must not be exceeded in inhabited places. Said exposure levels or limits range from 450 microW/cm² for a frequency of 900 MHz, up to 900 microW/cm² for a frequency of 1800 MHz, these being the two frequencies most often used in mobile telephony.

The most stringent scientific experts consider that the exposure limits recommended by the European Union are very high, and advise that as a preventive measure the maximum radiation intensity the user receives should not be greater than 0.1 microW/cm² (Resolution adopted by the Salzburg Conference of June 2000).

Density levels vary in inverse proportion to the square of the distance of the user from the antenna or radiation emitting source (calculated using the power flow density formula laid down by Standard CENELEC ENV 50166-2). It has accordingly been calculated that the radiation intensity received by the user of a conventional mobile phone that emits at a power of 0.250 W is 2200 microW/cm², when said user is situated some 3 cm away from the emitting antenna for that mobile phone. On the other hand, the intensity that same user receives when situated 150 cm away from the antenna is significantly lower, of the order of 0.8 microW/cm².

In view of the above-mentioned formula for calculating radiation intensity, it is important to note that, although the emitting power of telephony base station antennas is very much greater than that from the antennas of mobile telephones, the considerable distance that usually lies between the mobile telephone user and the said antenna base means that in most cases the radiation intensity the user receives from said base antenna has lower values than the exposure limits recommended by the European Union.

It is clear from the above that the source of radiation harmful for the health of a conventional mobile telephone user is the one that comes from the antenna of the very telephone he uses by placing it close to his ear, and thus at a distance equal to or less than 3 cm from said antenna or emitting source. At that distance the user is subjected to an intensity of radiation from the antenna of his telephone that easily exceeds the reference limits or levels laid down by the European Union.

Known in the market are personal communication systems based on the use of mobile telephony that include protection devices against the radiation generated during their use.

Spanish patent ES 2153288 discloses a mobile telephone comprising two units. A first detachable unit of elements, or radiation emission-reception unit, which includes the emitting-receiving module as such, and a second fixed unit of elements, or personal communication unit, which is integral to the casing of the mobile telephone and includes the speaker element, the microphone, the screen and the keypad. During the communication the emitting-receiving unit can be detached from the casing of the mobile phone and placed a sufficient distance away from the personal communication unit so that the power flow density of the radiation that reaches said personal communication unit, and therefore the user, is lower than a predetermined maximum value. The communication between said emitting-receiving unit and said personal communication unit is implemented by cable or wirelessly. The predetermined maximum power flow density value is preferably less than 1 microW/cm².

The personal communication system described in the Spanish patent has the advantage of permitting the emitting-receiving module to be further away from the ear of the user. The intensity of the electromagnetic field that comes from said module and is received by the user is therefore significantly reduced, for, as outlined, the intensity of the electromagnetic field varies in inverse proportion to the square of the distance of the user from the antenna or emitting source.

The system disclosed in Spanish patent ES 2153288 nevertheless has the disadvantage of being impractical for use when walking, and not very effective in protecting against radiation.

Indeed, in order to achieve a reduction of the intensity of the electromagnetic field to below 1 microW/cm², the emitting-receiving unit has to be moved to a distance of between 100 cm and 150 cm away, for mobile phones with an emission power of 0.125 W and 0.250 W, respectively. This means that users of the system described in the Spanish patent, while receiving or making a call, must uncouple the emitting-receiving unit from the casing of the telephone and place it in a far-removed place. This is very inconvenient in practice, for if the user is in the street or moving from one place to another he will find it difficult to carry out this decoupling operation and find a place to leave the emitting-receiving unit while he makes or receives the call, and so will not actually carry out this decoupling of the emitting-receiving unit.

Another disadvantage presented by the system described in the Spanish patent is that the telephone, due to having two independent units coupled together, does not provide a very compact design and is very complex, which makes the manufacturing process more expensive and therefore increases the final retail price of the telephone.

### DESCRIPTION OF THE INVENTION

The objective of this invention is to resolve the disadvantages mentioned, by developing a personal communication system based on the use of mobile telephony that is very practical, especially for use while on the move, and that is easy to manufacture.

In accordance with this objective, a first aspect of this invention is to provide a system that includes a telephone with a first emitting unit and a first receiving unit of radiofrequency electromagnetic waves and/or microwaves, a screen, a keypad, a loudspeaker element, a microphone and means of supplying energy, and is characterised in that it includes at least one independent device, said device including a second radiofrequency electromagnetic wave and/or microwave emitting unit and energy supply means; and in that said system includes means for connecting said device and said telephone wirelessly and means for deactivating said first emitting unit of said telephone and for activating said second emitting unit of said device, so that when said second emitting unit of said device is activated the communication takes place in such a way that at least the vital organs of the user receive a radiation power flow density lower than a predetermined maximum value.

Thanks to these characteristics, the system of this invention presents the advantage of being very practical, since users can use the mobile telephone of the system just as they would use a conventional mobile phone, without need to uncouple any emitting unit or, therefore, to alter any acquired telephone-use habits or customs. They need have available only the device for implementing the high-power emission, stowed in a bag, briefcase or pocket. It should further be taken into account that users can have several emitting devices for leaving in various places in addition to in a bag, briefcase or pocket, so that they could have another one in the office, another in the car, another at home, and so forth. Users can thus use the mobile telephone of the system anywhere, like a conventional telephone, without any need for manipulating said mobile phone each time they make or receive a call. Moreover, if users do not have the device, either because they lost it or left it somewhere, the mobile telephone of this invention has a first emitting unit and receiving unit built into its casing to allow the mobile phone to be used, although in this case without protection against radiation.

Another advantage presented by the system of the invention is that the design of the mobile telephone can be kept as compact and simple as that of conventional mobile phones, since different units or components do not have to be designed. It should be further noted that if the user habitually uses the mobile phone with the emitting unit of the device activated, the size of the telephone battery, and therefore also the size of said mobile phone itself, can be reduced considerably.

Preferably, said device includes means for securing it to the body of the user and, advantageously, said means include a band-type support designed for placing around the ankle of said user.

Thanks to these characteristics, the system is especially practical for itinerant use, since the user can transport the device without being aware of it nor having to pay attention to it while making and receiving calls, by placing it on the part of the body furthest away from vital organs such as the head and/or the heart, thereby ensuring that the intensity of the electromagnetic field that those organs receive is preferably lower than 1 microW/cm².

Advantageously, the side of said support in contact with the ankle of the user can be protected with an additional protection element.

According to one embodiment of the system of this invention, said device further includes a second receiving unit, and said system includes means for deactivating said first receiving unit of the telephone and for activating said second receiving unit of the device. All communication with the antenna of the telephony base station is thus carried out from the device.

According to a second aspect of this invention, a telephone is provided for using with the system claimed, which telephone includes a radiofrequency electromagnetic wave and/or microwave emitting unit and receiving unit, a screen, a keypad, a loudspeaker element, a microphone, a casing and energy supply means, and is characterised in that it includes means for deactivating said emitting unit and activating a second external emitting unit situated in a device located at a predetermined distance from said telephone, and means for connecting said telephone and said device wirelessly.

These characteristics provide a telephone of compact and simple design that can be used either in a conventional manner, by using the emitting-receiving unit of telephone, or in accordance with the system of this invention, in order to protect the user from radiations, by deactivating the emitting unit of the telephone and activating the second external emitting unit situated in the device.

According to one embodiment of this invention, said telephone further includes means for deactivating said receiving unit and for activating a second external receiving unit situated in said device. Said telephone therefore enables all the communication with the telephony base station to be carried out from said device.

According to a third aspect of this invention a device is provided for using with the system claimed, and is characterised in that it comprises a radiofrequency electromagnetic wave and/or microwave emitting unit, energy supply means, means for connecting said device wirelessly with a telephone situated at a predetermined distance from said device, and means for activating said emitting unit and deactivating the emitting unit of said telephone.

Thanks to these characteristics, a device is obtained that can be used with any conventional mobile telephone set up to work with the system of this invention.

Preferably, said device includes means for securing it to the body of the user.

The fact that the device can be secured to the body of the user thus means that the device can be transported easily without any need for the user to pay it any attention while receiving or making calls.

According to one embodiment of this invention, said device also includes a radiofrequency electromagnetic wave and/or microwave receiving unit and means for activating said receiving unit and deactivating the receiving unit of said telephone.

All communication with the telephony base station can thus be carried out from this device.

### BRIEF DESCRIPTION OF THE DRAWINGS

For a better understanding of all that has been outlined, some drawings are attached that show, schematically and solely by way of non-restrictive example, a practical case of embodiment.

In said drawings,

FIG. 1 is a diagram that shows the functioning of a preferred embodiment of the system of this invention.

FIG. 2 is a diagram that shows the functioning of an embodiment of the system of this invention.

FIG. 3 shows a perspective view of a device of the preferred embodiment of FIGS. 1 and 2.

### DESCRIPTION OF A PREFERRED EMBODIMENT

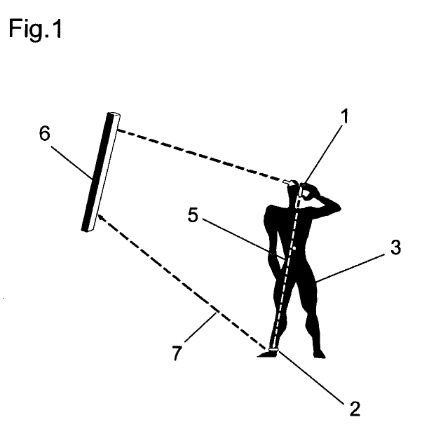

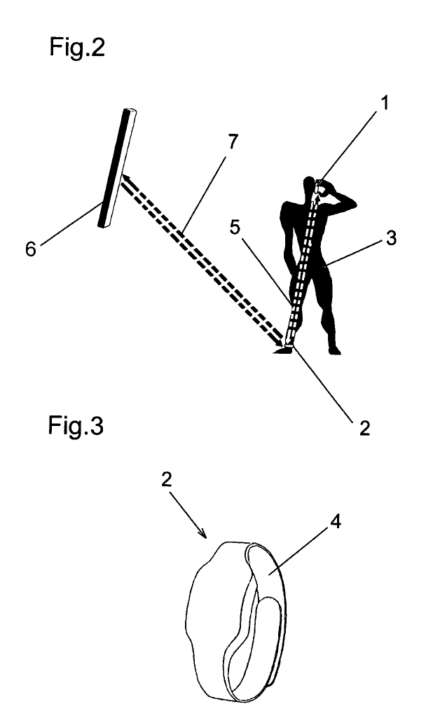

FIGS. 1 and 2 show two embodiments of the system of this invention that comprise a telephone 1 and a device 2 attached to the ankle of the user 3.

FIG. 3 shows a perspective view of said device 2 that includes a support 4 by way of a band, designed for fitting on the ankle.

In the two embodiments of FIGS. 1 and 2, the telephone 1 includes a first emitting unit and a first receiving unit of radiofrequency electromagnetic waves and/or microwaves, a screen, a keypad, a loudspeaker element, a microphone, a battery and means for deactivating said first emitting and receiving units and activating some second emitting and receiving units, mounted on device 2, together with a battery for powering said device 2.

The device 2 and the telephone 1 are connected to each other wirelessly. This wireless communication is short-distance, and thus generates an electromagnetic field of radiofrequency waves and/or microwaves 5 of very low radiation intensity, since the emission power needed to carry out such wireless communication over a short distance is also very low.

The system of this invention comes into operation once the user 3 has activated the second emitting unit of the device 2 and deactivated the first emitting unit of the telephone 1. From this time the emission of calls is controlled by said second emitting unit of the device 2 that is connected with the antenna 6 of the telephony base station through the appropriate electromagnetic radiofrequency waves and/or microwaves 7.

In the embodiment of FIG. 2, the user 3 has also activated the receiving unit of the device 2 and has deactivated the receiving unit of the telephone 1. All communication with the antenna 6 of the telephony base station is thus carried out from the device 2. In the embodiment of FIG. 1, on the other hand, only the emitting unit of the telephone 1 is deactivated, so that reception of waves from that antenna 6 continues to be carried out at the telephone 1.

As noted in the description and as can be seen in Table 1 attached, the intensity of the electromagnetic field generated by the radiation 7 sent to the antenna 6 of the telephony base station is high (of the order of 2200 microW/cm² for a 0.250 W emitting source) in the vicinity of the emitting focus. These radiation values 7 exceed by far the reference levels recommended by the European Union.

TABLE 1
Values of the intensity of the electromagnetic field generated
by the emitting unit of two mobile telephones, measured at
different distances from said units. Intensity values expressed
in radiation power flow density levels.

| | | |
|---|---|---|
| | Emitting unit of | Emitting unit of |
| Distance to | 0.125 W power | 0.250 W power |

| | |
|---|---|
| the emitter | Power flow density |
| (cm) | (microW/cm²⁾ |

| | | |
|---|---|---|
| 3 | 1100 | 2200 |
| 5 | 400 | 800 |
| 10 | 100 | 200 |
| 50 | 4 | 8 |
| 100 | 1 | 2 |
| 150 | 0.4 | 0.8 |
| 180 | 0.3 | 0.6 |

In the system of the invention, the communication with the antenna 6 is carried out by means of the second emitting unit fitted onto the ankle of the user 3. During said communication, therefore, the radiation emitting source 7 remains further than 150 cm away from the head and the heart of the user 3. At this distance the intensity of radiation 7 of the electromagnetic field generated by the emission source ranges between 0.4 microW/cm² and 0.8 microW/cm², for emission sources of 0.125 W and 0.250 W, respectively. These values are very much lower than the reference levels recommended by the European Union, and very close to the 0.1 microW/cm² value recommended as a preventive measure by the most stringent scientific experts.

In the light of the above it is clear that with the system of this invention, the user 3 is protected from levels of radiation 7 that are detrimental to his/her health, since the intensity of the electromagnetic field of waves 7 received by the vital organs of the user 3 at a distance of not less than 150 cm from the emitting unit is always very close to the 0.1 microW/cm² recommended by the scientific experts.

Unlike the systems described in the state of the art, the system of this invention is very practical, since the user 3 can use the mobile telephone 1 of the system like a conventional telephone, and transport the device 2 responsible for the emission in a convenient manner, without need to pay it any attention while the communication is taking place.

The embodiments disclosed in both FIG. 1 and FIG. 2 present the advantage that, as the device 2 is secured to the ankle of the user 3, the system is especially useful for use when moving and very effective for protection against radiation, for a certain safety distance between the emission source, located in said device 2, and the head of the user 3, is always ensured.

The embodiment of FIG. 1 has the advantage over the embodiment of FIG. 2 that, as the receiving unit of the telephone 1 is activated, reception of waves from the base station antenna 6 continues to be carried out in the telephone 1, so that in relation to the embodiment of FIG. 2, the intensity of radiation 5 the user 3 receives once generated by wireless communication is reduced.

Moreover, when compared with the telephones of the systems described in the state of the art, the telephone 1 of this invention also has the advantage that, due to it having a first emitting-receiving unit, it can be used for making calls without the device 2.

1. Personal communication system based on the use of mobile telephony and that includes means of protection against the radiation generated during its use, which includes a telephone (1) with a first emitting unit that allows communicating with the antenna (6) of the telephony base station and a first radiofrequency electromagnetic wave and/or microwave receiving unit, a screen, a keypad, a loudspeaker element, a microphone and energy supply means, characterised in that it includes at least one independent device (2), said device (2) including a second radiofrequency electromagnetic wave and/or microwave emitting unit (7) that allows communicating with the antenna (6) of the telephony base station and energy supply means; and in that said system includes means for connecting said device (2) and said telephone (1) wirelessly and means for deactivating said first emitting unit of said telephone (1) and for activating said second emitting unit of said device (2), so that when said second emitting unit of said device (2) is activated, the communication takes place in such a way that at least the vital organs of the user receive a radiation power flow density lower than a predetermined maximum value.

2. Communication system according to claim 1, characterised in that said device (2) further includes a second receiving unit, and said system includes means for deactivating said first receiving unit of the telephone (1) and for activating said second receiving unit of the device (2).

3. Communication system according to claim 1, characterised in that said device (2) includes means for securing it to the body of the user (3).

4. Communication system according to any of the preceding claims, characterised in that said maximum radiation power flow density value is 1 microW/cm².

5. Telephone according to the system of claim 1, which includes a radiofrequency electromagnetic wave and/or microwave emitting unit and receiving unit (7), said emitting unit allowing communicating with the antenna (6) of the telephony base station, a screen, a keypad, a loudspeaker element, a microphone, a casing and energy supply means, characterised in that it includes means for deactivating said emitting unit and activating a second external emitting unit situated in a device (2) located at a predetermined distance from said telephone (1), and means for connecting said telephone (1) and said device (2) wirelessly.

6. Telephone according to claim 5, characterised in that it further includes means for deactivating said receiving unit and for activating a second external receiving unit situated in said device (2).

7. Device according to the system of claim 1, characterised in that it includes at least a radiofrequency electromagnetic wave and/or microwave emitting unit (7) that allows communicating with the antenna (6) of the telephony base station, energy supply means, means for connecting said device (2) wirelessly with a telephone (1) situated at a predetermined distance from said device (2), and means for activating said emitting unit and deactivating the emitting unit of said telephone (1).

8. Device according to claim 7, characterised in that it further includes a radiofrequency electromagnetic wave and/or microwave receiving unit and means for activating said receiving unit and deactivating the receiving unit of said telephone (1).

9. Device according to claim 7, characterised in that it includes means for securing to the body of the user (3).
